(19) United States
(12) Patent Application Publication
(10) Pub. No.: US 2017/0227832 A1
(43) Pub. Date: Aug. 10, 2017

(54) Collapsible Light Softbox

(71) Applicant: Ye Xu, Sugar Land, TX (US)

(72) Inventor: Ye Xu, Sugar Land, TX (US)

(21) Appl. No.: 15/017,883

(22) Filed: Feb. 8, 2016

(51) Int. Cl. G03B 15/06; F21V 7/18; F21V 11/18; F21V 13/10; F21V 17/00; F21V 17/10

(52) U.S. Cl. CPC G03B 15/06; F21V 17/002; F21V 17/108; F21V 11/18; F21V 13/10; F21V 7/18

(57) ABSTRACT

Provided are foldable light softboxes for users to conveniently carry around. The softbox comprises a body portion, a set of flexible and foldable frames, means for switching the softbox between an unfolded state and a collapsed state, and means for fitting the softbox over light sources of different sizes. The body portion of the softbox comprises a front panel, a back panel and a strip of material that circumferentially attached to the front panel to the back panel. The flexible and foldable frames are attached along the circumferences of the front and back panels. The softbox can be folded to fit in a circular container, for example, a bag.

### BACKGROUND OF THE INVENTION

Field of the invention

The present invention generally relates to the field of photography or cinematography. More specifically, the present invention relates to a collapsible and portable light softbox.

Description of the Related Art

As the technology for cell phone cameras improves drastically, users are increasingly using their cell phones to shoot photos and footages at a prosumer or professional level. Although cameras have become much more portable, some essential accessories for cameras, especially lighting devices, remain bulky, and thus are difficult to be carried around.

The softbox is one of the most commonly used pieces of photographic lighting equipment. It is generally attached over a direct light source, such as a light bulb, to create even and diffused light.

Unfortunately, these light softboxes are commonly too large for the users to conveniently carry them. Indeed, the need of excessively packing and unpacking large bags for a softbox light defeats the purpose of using portable cameras or other portable photographic equipment.

Therefore, there is a recognized need in the art for a portable softbox light, which users can conveniently pack in a small space and carry with them. Particularly, the prior art is deficient in this aspect. The present invention fulfills this long-standing need and desire in the art.

### SUMMARY OF THE INVENTION

The present invention is directed to a collapsible light softbox. The softbox comprises a front panel comprising a first foldable light-diffusing material, and a back panel comprising a second foldable material having an opening through which a light source fits. The front panel and the back panel are circumferentially connected via a strip of the second foldable material. A set of flexible and foldable frames is disposed along a circumference of the front panel and back panel. The softbox further comprises a means for switching the softbox between an unfolded state and a collapsed state.

The present invention is further directed to a foldable light softbox. The softbox comprises a body portion, a set of flexible and foldable frames, means for switching the softbox between an unfolded state and a collapsed state, and means for securing the softbox over light sources of different sizes. The body portion of the softbox comprises a front panel comprising a first foldable light-diffusing material, a back panel comprising a second foldable material and a strip of the second foldable material circumferentially disposed between and attached to the front panel to the back panel. The flexible and foldable frames are attached along the circumferences of the front panel and back panel.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 is a perspective view of the collapsible light softbox from the front and left side. The softbox is fully unfolded with the light-diffusing surface facing the front and the magnetic metal suspension rods locked in the support positions.

FIG. 2 is back view of the collapsible light softbox showing two adjustable elastic bands attached across the opening thereof.

FIG. 3 is a perspective view of the collapsible light softbox from the back and left side.

FIG. 4 depicts the mechanism of the magnetic metal suspension rods switching between support/unfolded and collapsed positions.

FIG. 5 depicts the magnetic metal suspension rods are unlocked from the support position and folded together when the softbox collapses.

FIG. 6 depicts the bags that the softbox is fit into when it is fully collapsed and folded into circular shape.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

In one embodiment of the present invention, there is provided a softbox comprising a front panel comprising a first foldable light-diffusing material; a back panel comprising a second foldable material having an opening through which a light source fits; a set of flexible and foldable frames attached along a circumference of the front panel and back panel; a strip of the second material circumferentially disposed between and attached to the front panel and back panel; and means for switching the softbox between an unfolded state and a collapsed state. In this embodiment, the softbox may further comprise a means for securing the softbox over light sources of different sizes.

Further still in this embodiment, the means for fitting the softbox onto light sources of different sizes may comprise, for example, Velcro bands disposed over two opposite sides of the opening on the back panel; and a plurality of elastic bands across the opening on the back panel and attached on the Velcro bands.

In this embodiment, the flexible and foldable frames comprise magnetic iron magnetic iron, alloy, aluminum, plastic or a combination thereof. The flexible and foldable frames are configured to be folded to about ¼ to ¾ smaller than the surface area of the front or back panel.

In a preferred embodiment, an inner surface of the second foldable material comprises a reflective material. Representative examples for the reflective material include but are not limited to, an aluminized fabric, aluminum foil, soft or rigid surface with reflective functionality or a combination thereof.

Further in this embodiment, the means for switching the softbox between an unfolded state and a collapsed state comprise a plurality of magnetic metal suspension rods disposed along circumferences of the front panel and back panel, each rod has one end attached to the front panel and the other end attached to the back panel.

In another embodiment of the present invention, there is provided a foldable light softbox comprising a body portion, a set of flexible and foldable frames, means for switching the softbox between an unfolded state and a collapsed state, and means for securing the softbox over light sources of different sizes. The body portion of the softbox comprises a front panel comprising a first foldable light-diffusing material, a back panel comprising a second foldable material and a strip of the second foldable material circumferentially disposed between and attached to the front panel to the back panel. The flexible and foldable frames are attached along the circumferences of the front panel and back panel.

In this embodiment, an opening is disposed on the back panel to secure a light source therein. Further in this embodiment, the exemplary materials for the flexible and foldable frames include but are not limited to magnetic iron, alloy, aluminum, plastic or a combination thereof. Preferably, the flexible and foldable frames are configured to be folded to about ¼ to ¾ smaller than the surface area of the front or back panel. The frames are immediately recoverable to an original dimension when it is not folded.

Further still in this embodiment, an inner surface of the strip of the second foldable material is reflective. The inner surface comprises an aluminized fabric surface, aluminum foil, soft or rigid surface with reflective functionality or a combination thereof.

Further in this embodiment, the means for switching the softbox between an unfolded state and a collapsed state comprise a plurality of magnetic metal suspension rods disposed along circumferences of the front panel and back panel, each rod has one end attached to the front panel and the other end attached to the back panel.

Further still in this embodiment, the means for securing the softbox onto light sources of different sizes may comprise, for example, Velcro bands disposed over two opposite sides of the opening on the back panel; and a plurality of elastic bands across the opening on the back panel and attached on the Velcro bands.

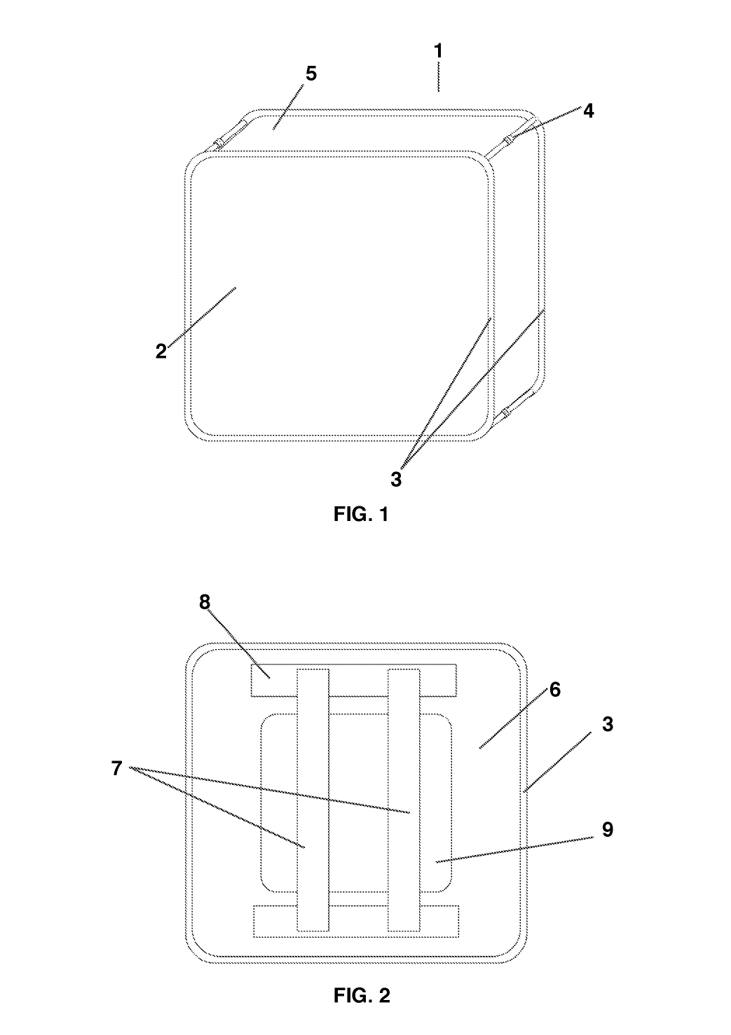

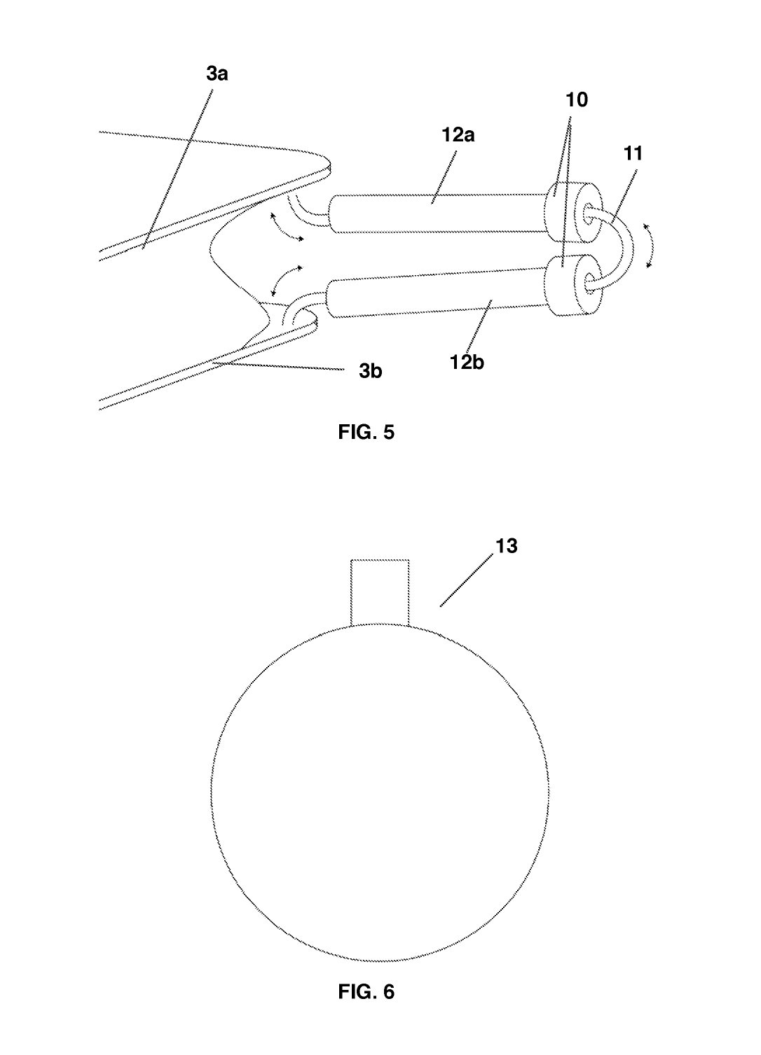

With reference to the attached drawings, provided herein are softboxes 1 that can be collapsed and folded to fit in a round shaped or circular container, for example, a bag (FIG. 1). The softbox comprises a front panel 2 that is made of a first foldable light-diffusing material through which light is evenly diffused, a back panel 6 comprising a second foldable material having an opening thereon through which a light source fits, a strip of the second foldable material 5 circumferentially disposed between and attached to the front panel and the back panel, a front frame 3a and a back frame 3b, and a means for switching the strip of material 5 between unfolded and folded states (FIG. 1). Examples for the first foldable light-diffusing material include but are not limited to a fabric, a flexible, foldable plastic sheet, a cloth, a polymer or a combination thereof. The second foldable material may include but are not limited to a fabric, a cloth, a plastic sheet, or a combination thereof. The second foldable material is not light-diffusing. The means for switching may comprise a plurality of magnetic metal suspension rods 4 evenly distributed along the circumference of the front panel 2 and back panel 6. Each of the magnetic metal suspension rods 4 comprises two sections 12a,b, which are configured to confer rigidity to the unfolded softbox when it is connected (FIG. 4) and collapse the softbox when they bend to each other (FIG. 5).

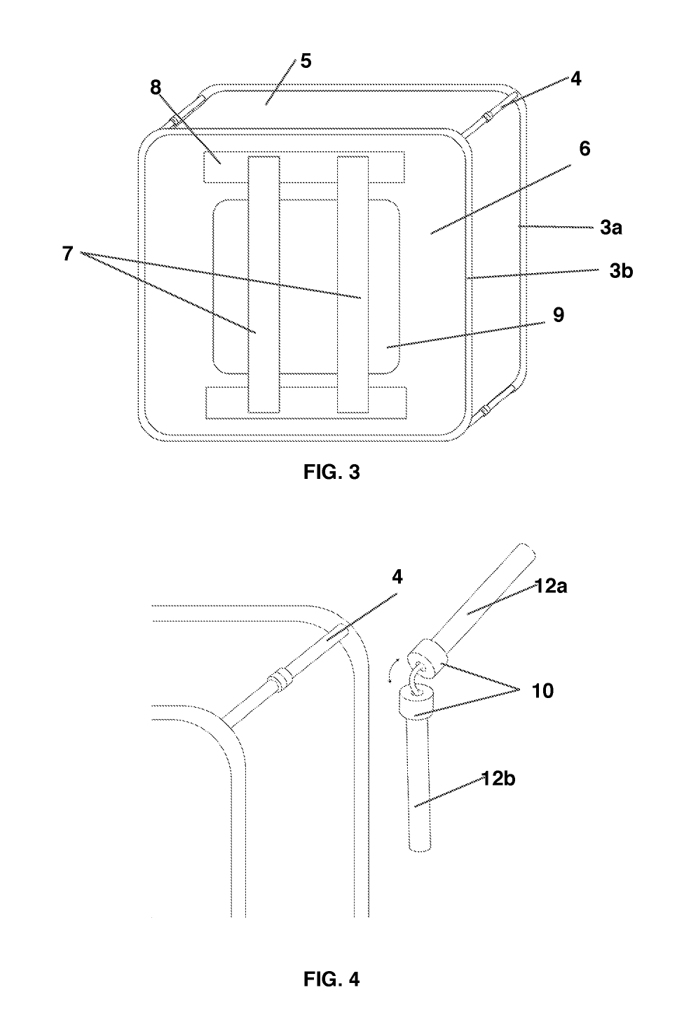

The back panel 6 of the softbox is in substantially the same dimensions as the front panel. The back panel 6 comprises an opening 9 disposed in the center thereof configured to receive a light source therethrough, two or more elastic bands 7 disposed across the opening, and means 8 for adjustably attaching the elastic bands thereto. For example, the means for attaching may be Velcro strips disposed on the elastic bands and the back panel of the box so that the distance between the elastic bands can be adjusted (FIGS. 2 and 3). The softbox is fully unfolded showing the adjustable elastic bands attached across the opening on the backside thereof (FIG. 3).

The magnetic metal suspension rod 4 comprises two sections of rods 12a,b, each attached to the front and back panel respectively, a piece of magnet 10 on each of the section at the interface between them, a string 11 disposed through and connecting the two sections of the rod (FIGS. 4 and 5). When the two magnet pieces are facing each other, the magnetic force reinforces them together and supports the box in an unfolded position (FIG. 4). When the two sections are separated at the interface thereof, the box loses the support between the front panel and back panel, thus collapsing. The front and back frames of the softbox may be made of flexible strings that can be twisted and folded with external force, and recover to the original shape when the force is removed. Therefore, after the front and back panel collapses against each other, the front and back frame can be twisted and folded into a circular shape that is less than about one fourth of the original surface area of the front or back panel. An exemplary material for the frame is magnetic iron. The twisted and folded softbox can fit into a carrying container such as a compact bag 13 that can be conveniently carried around.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

What is claimed is:

1. A collapsible light softbox comprising:
a front panel comprising a first foldable light-diffusing material;
a back panel comprising a second foldable material having an opening through which a light source fits;
a set of flexible and foldable frames attached along a circumference of said front panel and back panel;
a strip of the second foldable material circumferentially disposed between and attached to said front panel and back panel; and
means for switching the softbox between an unfolded state and a collapsed state.

2. The collapsible light softbox of claim 1, further comprising means for securing said softbox over light sources of different sizes.

3. The collapsible light softbox of claim 2, wherein said means for securing the softbox onto light sources of different sizes comprises Velcro bands disposed over two opposite sides of said opening on the back panel; and a plurality of elastic bands across said opening on the back panel and attached on said Velcro bands.

4. The collapsible light softbox of claim 1, wherein said flexible and foldable frames comprise magnetic iron, alloy, aluminum, plastic or a combination thereof.

5. The collapsible light softbox of claim 1, wherein said flexible and foldable frames are configured to be folded to about ¼ to about ¾ smaller than the surface area of the front or back panel.

6. The collapsible light softbox of claim 5, wherein said flexible and foldable frame is recoverable to its original dimension when it is not folded.

7. The collapsible light softbox of claim 1, wherein an inner surface of said foldable second material comprises a reflective material.

8. The collapsible light softbox of claim 7, wherein said reflective material comprises an aluminized fabric, aluminum foil, soft or rigid surface with reflective functionality or a combination thereof.

9. The collapsible light softbox of claim 1, wherein said means for switching the softbox between an unfolded state and a collapsed state comprise a plurality of magnetic metal suspension rods disposed along circumferences of said front panel and back panel, each rod having one end attached to the front panel and the other end attached to the back panel.

10. A foldable light softbox, comprising
a body portion comprising a front panel comprising a first foldable light-diffusing material, a back panel comprising a second foldable material and a strip of the second foldable material circumferentially disposed between and attached to the front panel and the back panel;
a set of flexible and foldable frames attached along circumferences of said front panel and back panel;
means for switching the softbox between an unfolded state and a collapsed state; and
means for securing said softbox over light sources of different sizes.

11. The foldable light softbox of claim 10, wherein an opening is disposed on said back panel for securing a light source therein.

12. The foldable light softbox of claim 10, wherein said flexible and foldable frames comprises magnetic iron, alloy, aluminum, plastic or a combination thereof.

13. The foldable light softbox of claim 10, wherein said flexible and foldable frames are configured to be folded to about ¼ to ¾ smaller than the surface area of the front or back panel.

14. The foldable light softbox of claim 13, wherein said flexible and foldable frames are recoverable to an original dimension when it is not folded.

15. The foldable light softbox of claim 10, wherein an inner surface of said second foldable material comprises a reflective material.

16. The foldable light softbox of claim 15, wherein said inner surface of the second foldable material comprises an aluminized fabric surface, aluminum foil, soft or rigid surface with reflective functionality or a combination thereof.

17. The foldable light softbox of claim 10, wherein said means for switching the softbox between a folded and a collapsed positions comprise a plurality of magnetic metal suspension rods disposed along circumferences of said front panel and back panel, each rod has one end attached to the front panel and the other end attached to the back panel.

18. The foldable light softbox of claim 10, wherein said means for securing the softbox onto light sources of different sizes comprises Velcro bands disposed over two opposite sides of said opening on the back panel; and a plurality of elastic bands across said opening on the back panel and attached on said Velcro bands.
